(19) United States
(12) Patent Application Publication
(10) Pub. No.: US 2024/0366449 A1
(43) Pub. Date: Nov. 7, 2024

(54) INFLATABLE SUPPORT

(71) Applicant: GBUK Group Limited, Selby North Yorkshire (GB)

(72) Inventors: Ross Allsopp, Selby North Yorkshire (GB); Joseph COWAN, Selby North Yorkshire (GB); Lee QUICKMIRE, Selby North Yorkshire (GB); Nicholas SCARD, Selby North Yorkshire (GB)

(21) Appl. No.: 18/688,487

(22) PCT Filed: Aug. 31, 2022
(86) PCT No.: PCT/GB2022/052224

§ 371 Date: Mar. 1, 2024

(30) Foreign Application Priority Data
Sep. 24, 2021 (GB) 2113641.1

(51) Int. Cl. A61G 7/10; A61G 1/013

(52) U.S. Cl. CPC A61G 7/1021; A61G 1/013; A61G 2200/16

(57) ABSTRACT

An inflatable support for lifting and supporting a patient, comprising two aligned and spaced apart inflatable cells with a central channel between the cells; and a connection sheet attached to an upper sheet of each inflatable cell and extending across the central channel. The inflatable support may be snugly received in a bag, and the invention relates also to a kit comprising an inflatable support and bag; and to a system comprising multiple inflatable supports.

### FIELD OF INVENTION

The present invention relates to an inflatable support for lifting and supporting a patient, particularly a bariatric patient, as part of an inflatable support system.

### BACKGROUND ART

Hospital patients often have either chronic or short-term mobility issues which require the use of patient handling equipment such as straps, slings, sheets and transfer mattresses to safely move them. Such patient handling devices need to be placed underneath a patient before use and removed after use.

This procedure can be difficult for bariatric patients. Several strong patient handlers may be required to lift or roll all or part of the patient in order to position a patient handling device such as a sling underneath. This can lead to injury to the patient or handlers.

The friction caused by sliding a sheet, sling or transfer mattress underneath a patient can cause chafing to the patient's skin and may be painful, particularly if the patient has pressure ulcers.

Although some handling devices (such as slings) are designed to be left underneath a patient on a bed or a chair, this is not always possible. The device will need to be removed regularly to allow the patient and device to be cleaned and the device will most likely need to be removed during surgery to reduce the risk of infection.

### SUMMARY OF THE INVENTION

The present invention seeks to provide a device and system to facilitate the safe positioning and removal of patient handling devices and other equipment underneath a patient (particularly a bariatric patient) with restricted mobility.

Viewed from a first aspect the present invention provides an inflatable support comprising: first and second inflatable cells aligned and spaced apart along a longitudinal axis to define a central channel, wherein each inflatable cell includes an upper sheet in a first plane substantially parallel to the longitudinal axis, a lower sheet in a second plane substantially parallel to the first plane and to the longitudinal axis, an inflatable chamber between the upper and lower sheets, and an inflation valve in fluid communication with the inflatable chamber; and a connection sheet attached to the upper sheet of each inflatable cell, wherein the connection sheet has a conjoining portion extending across the central channel to connect the longitudinally spaced apart first and second inflatable cells.

The inflatable support can be positioned on a substrate such as a bed or a table with the longitudinal axis of the support extending substantially across the substrate from left to right (i.e. sideways) underneath a patient with mobility issues. The support can then be inflated to raise part of the patient's body off the substrate, therefore facilitating the positioning of patient handling devices or other equipment underneath the patient. Two or more supports can be arranged substantially parallel underneath the patient from head to feet to facilitate lifting of the entire patient away from the substrate.

By providing two longitudinally spaced cells which are inflatable independently via individual valves, one side of the patient can be lifted or lowered independently of the other side of the patient. This could facilitate repositioning or turning of the patient, or cleaning or examination of part of the patient. The central channel between the cells can also be used to position or remove patient handling devices.

Each inflatable cell may have a side wall attached to and connecting a perimeter of the upper sheet and a perimeter of the lower sheet, and one or more baffles attached to and connecting the upper and lower sheets within the cavity. The side walls and baffles help to flatten the upper sheet of the cell when inflated to provide a more even surface to support the patient. The baffles are preferably arranged in a transverse direction.

Each inflatable cell is preferably substantially rectangular having a length extending along the longitudinal axis and a width perpendicular to the longitudinal axis. Each inflatable cell may have a length of between 50 cm and 100 cm, or preferably between 60 cm and 80 cm. Each inflatable cell may have a width of between 30 cm and 60 cm, or preferably between 35 cm and 50 cm. Each inflatable cell may have a depth (i.e. the separation distance between the lower sheet and upper sheet when fully inflated) of between 7 cm and 15 cm, e.g. about 10 cm.

The inflation valve is preferably positioned at or towards an external facing end of each inflatable cell. This increases the accessibility of the inflation valve to operatives. One or each inflatable cell may further comprise a handle at or towards an external facing end. The handle may be integrally formed with the inflatable cell, or may be attached to the inflatable cell, for example by stitching or welding. Preferably the handle is composed of a woven fabric, e.g. a webbing fabric.

Each inflatable cell may be composed of a flexible non-porous material, e.g. natural or synthetic rubber, a nylon material with a polyurethane coating, a polyethylene vinyl acetate (PEVA) or a polyvinyl chloride (PVC).

The connection sheet may extend over a portion of or the entirety of the upper sheet of each inflatable cell. Preferably the connection sheet extends over an entirety of both upper sheets.

The connection sheet may be composed of a non-porous, flexible material. The connection sheet may be composed of the same or a different material as the inflatable cells. The connection sheet may be attached to the inflatable cells by stitching or welding.

The first and second inflatable cells may be spaced apart to define a central channel having a width of at least 10 cm. Preferably the central channel has a width of between 15 cm and 30 cm, e.g. about 20 cm.

The inflatable support may further comprise an elongate bag to surround and contain the inflatable cells and connection sheet, wherein the bag is sized to snugly fit around the inflatable cells and connection sheet when the cells are fully inflated and has a top cover positioned or positionable over the upper sheets and the connection sheet; and a bottom cover positioned or positionable over the lower sheets. The bag advantageously facilitates repeated use of the inflatable support with the same or different patient, by preventing or limiting soiling of or damage to the inflatable cells. The bag can be removed after use and cleaned for reuse or replaced.

The top cover and the bottom cover may be attached together along each longitudinal edge to prevent fluid from soiling or damaging the inflatable cells. Preferably the top and bottom covers are directly attached to each other along each longitudinal edge. This advantageously provides the bag with a tapered leading edge to facilitate insertion underneath a patient. Alternatively the bag may include longitudinal side strips between the top and bottom covers. The elongate bag may further comprise an aperture at each longitudinal end to facilitate access to the inflation valve and to allow the cells and connection sheet to be removed from the bag when deflated. Each aperture preferably has a seam around its perimeter to prevent the bag tearing or fraying as the inflatable cells are inserted or removed.

The top cover, bottom cover and longitudinal side strips (where present) of the bag are preferably composed of a flexible, non-porous material e.g. a nylon sheet. The top and bottom covers may be coated with a low friction material, for example polytetrafluoroethylene (PTFE), fluorinated ethylene propylene (FEP) or silicone. The low friction material may be applied to outward facing surfaces of the top and bottom covers and/or inward facing surfaces of the top and bottom covers.

In use, the bottom cover extends across the lower sheets of each inflatable pad, and across the central channel. When the pads are inflated, the flexible material of the bottom cover allows a central portion of the bottom cover to be pushed up and into the central channel to create an indentation to enable access underneath a patient or to the placement of items underneath the patient and inflatable support. The central portion of the bottom cover may be marked on the bag to enable medical staff to easily identify the location of the central channel in use.

Alternatively a pre-defined central indentation may be provided in the bottom sheet in a longitudinal position approximately mid-way along the length of the bag to align and fit within the central channel between the two inflatable cells.

The bag may be provided with one or more grip straps at each longitudinal end to facilitate movement of the inflatable support. The grip straps may be formed of a woven fabric, e.g. a webbing fabric, and may be stitched to the top and/or bottom covers. Preferably the bag is provided with a total of four grip straps, with two at each longitudinal end. Preferably a first end of each grip strap is attached to the top cover, and a second end of each grip strap is attached to the bottom cover.

Viewed from a second aspect the present invention provides a kit of parts comprising: a pair of inflatable cells, wherein each inflatable cell includes an upper sheet, a lower sheet, an inflatable chamber between the upper and lower sheets, and an inflation valve in fluid communication with the inflatable chamber; and an elongate bag, wherein the bag is sized to snugly fit around the inflatable cells when the cells are fully inflated and has a top cover positionable over the upper sheets and a bottom cover positionable over the lower sheets, and an aperture at each longitudinal end. The aperture facilitates access to the inflation valve of each inflatable cell and allows the cells to be inserted and removed from the bag.

The bag may be provided with a first fastener at or towards each longitudinal end, with each inflatable cell having a second fastener releasably engageable with the first fastener to secure the inflatable pad within the bag to maintain a separation distance between the two inflatable cells to define a central channel between the cells. In use, the central channel can facilitate repositioning or turning of the patient, or cleaning or examination of part of the patient. The central channel between can also be used to position or remove patient handling devices.

The pair of inflatable cells may be joined together by a connection sheet attached to the upper sheet of each inflatable cell. Each inflatable cell may have a side wall attached to and connecting a perimeter of the upper sheet and a perimeter of the lower sheet, and one or more baffles attached to and connecting the upper and lower sheets within the cavity.

The connection sheet may extend over a portion of or the entirety of the upper sheet of each inflatable cell. Preferably the connection sheet extends over an entirety of both upper sheets.

The connection sheet may be composed of a non-porous, flexible material. The connection sheet may be composed of the same or a different material as the inflatable cells. The connection sheet may be attached to the inflatable cells by stitching or welding.

Each inflatable cell is preferably substantially rectangular, and may have a length of between 50 cm and 100 cm, or preferably between 60 cm and 80 cm. Each inflatable cell may have a width of between 30 cm and 60 cm, or preferably between 35 cm and 50 cm. Each inflatable cell may have a depth (i.e. the separation distance between the lower sheet and upper sheet when fully inflated) of between 7 cm and 15 cm, e.g. about 10 cm. Where present, the baffles are preferably arranged widthwise across the inflatable cell.

The inflation valve of each inflatable cell is preferably positioned at or towards a first longitudinal end. Each inflatable cell may further comprise a handle positioned at or towards the first longitudinal end. The handle may be integrally formed with the inflatable cell, or may be attached to the inflatable cell, for example by stitching or welding. Preferably the handle is composed of a woven fabric, e.g. a webbing fabric.

Each inflatable cell may be composed of a flexible non-porous material, e.g. natural or synthetic rubber, a polyethylene vinyl acetate (PEVA) or a polyvinyl chloride (PVC).

The top cover and the bottom cover of the bag may be attached together along each longitudinal edge. The bag may include longitudinal side strips between the top and bottom covers to ensure that the bag contours and fits snugly around the inflatable cells when inflated. Each aperture preferably has a seam around its perimeter to prevent the bag tearing or fraying as the inflatable cells are inserted or removed.

The top cover, bottom cover and longitudinal side strips (where present) of the bag are preferably composed of a flexible, non-porous material e.g. a nylon sheet. The top and bottom covers may be coated with a low friction material, for example polytetrafluoroethylene (PTFE), fluorinated ethylene propylene (FEP) or silicone. The low friction material may be applied to outward facing surfaces of the top and bottom covers and/or inward facing surfaces of the top and bottom covers.

The bag may be provided with one or more grip straps at each longitudinal end. The grip straps may be formed of a woven fabric, e.g. a webbing fabric, and may be stitched to the top and/or bottom covers. Preferably the bag is provided with a total of four grip straps, with two at each longitudinal end. Preferably a first end of each grip strap is attached to the top cover, and a second end of each grip strap is attached to the bottom cover.

Viewed from a third aspect the present invention provides a system for lifting and supporting a patient, comprising two or more inflatable supports or kits as hereinbefore described.

Preferably the system comprises four inflatable supports or kits. The inflatable supports or kits can be positioned on a substrate such as a bed or a table transversely (i.e. with the longitudinal axis of the support extending substantially across the substrate from left to right) and longitudinally spaced apart underneath a patient with mobility issues.

Viewed from a fourth aspect the present invention provides an elongate bag to surround and contain the inflatable cells as hereinbefore described.

### BRIEF DESCRIPTION OF DRAWINGS

A specific implementation of the present invention will now be described, by way of example only, and with reference to the accompanying drawings in which:

FIG. 1 is a perspective view of an inflatable support according to a first aspect of the present invention in an inflated configuration.

FIG. 2 is an exploded perspective view of the inflatable support of FIG. 1.

FIG. 3 is a top view of the inflatable support of FIG. 1.

FIG. 4 is a longitudinal side view of the inflatable support of FIG. 1.

FIG. 5 is a perspective view of one inflatable cell of the inflatable support of FIG. 1.

FIG. 6 is a perspective view of the inflatable cell of FIG. 5 with a transparent side wall and upper sheet.

FIG. 7 is a perspective view of an elongate bag according for surrounding and containing the inflatable support of FIG. 1.

FIG. 8 is a perspective view of the elongate bag of FIG. 7 with a transparent top cover and side strips.

FIG. 9 is a perspective view of the inflatable support of FIG. 1 within the bag of FIG. 7.

FIG. 10 is a perspective view of the inflatable support of FIG. 1 within a transparent elongate bag.

FIG. 11 is a perspective view of a patient being supported by a system of inflatable supports.

FIG. 12 is an end view of the system of FIG. 11.

FIG. 13 is a side view of the system of FIG. 11.

### DETAILED DESCRIPTION OF PREFERRED EMBODIMENT OF THE INVENTION

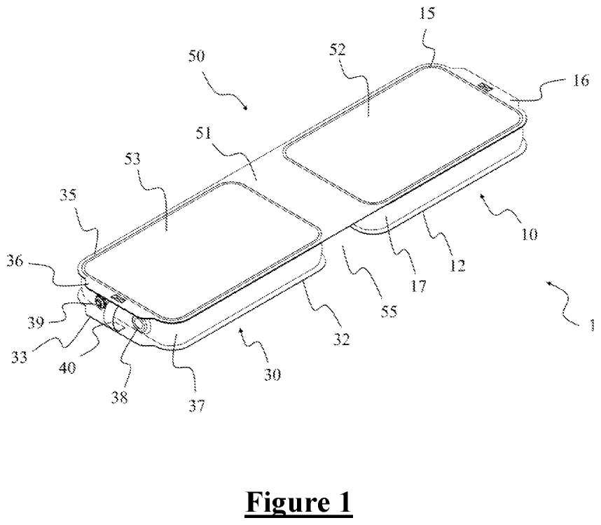

Referring initially to FIGS. 1 to 4, an inflatable support 1 is shown. The inflatable support 1 has an elongate shape with a first inflatable cell 10 and a second inflatable cell 30 longitudinally spaced apart from the first inflatable cell 10 to define a central channel 55.

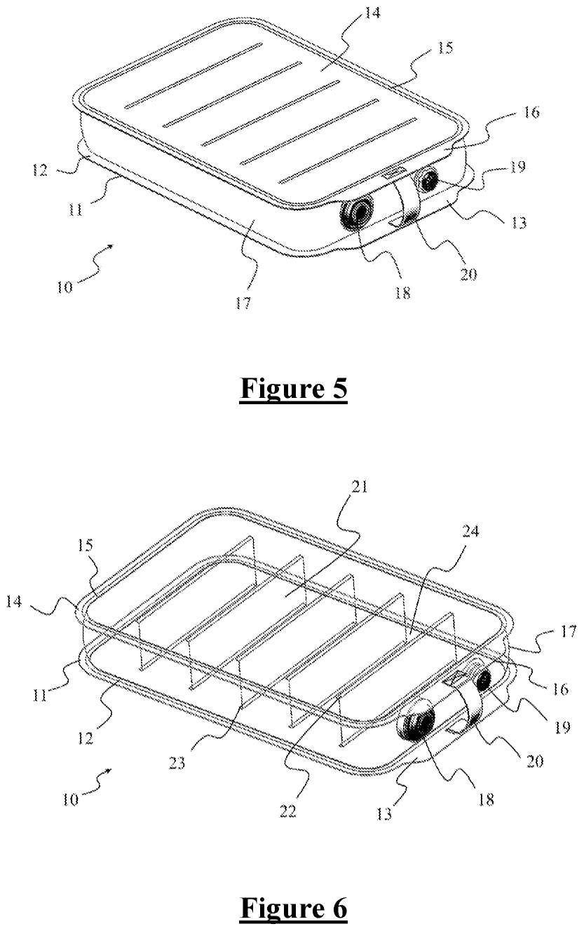

With reference now to FIGS. 5 and 6, each inflatable cell 10, 30 has a generally rectangular cross-section and a generally cuboid shape when inflated. The second inflatable cell 30 is substantially the same as the first inflatable cell 10 with each having an inflated length of 65 cm, an inflated width of 40 cm and an inflated depth of 10 cm. The central channel 55 separates the two inflatable cells 10, 30 by a distance of approximately 20 cm.

Each inflatable cell 10, 30 has a lower sheet 11, 31 and an upper sheet 14, 34. The lower and upper sheets are similarly sized and are attached together around their respective perimeters by a side wall 17, 37. The lower and upper sheets and side wall are composed of a nylon material with a polyurethane coating. The side wall 17, 37 and lower sheet 11, 31 are attached together by welding (e.g. HF welding) around the lower sheet perimeter 12, 32. The side wall 17, 37 and upper sheet 14, 34 are attached together by welding around the upper sheet perimeter 15, 35. The upper sheet, lower sheet and side wall together define an internal inflatable cavity 24, 44.

As best shown in FIG. 6, each inflatable cell 10, 30 has a set of transversely oriented baffles 21, 41 within the cavity 24, 44 between the lower and upper sheets. In this particular embodiment the baffles extend across a central 75% of the width of the cell 10, 30, with each cell having five baffles spaced longitudinally. The baffles 21, 41 are attached to the lower sheet 11, 31 by welding at a lower baffle join 23, 43 and are attached to the upper sheet 13, 34 by welding at an upper baffle join 22, 42. The baffles 21, 41 ensure that the inflatable cell 10, 30 retains a substantially cuboid shape with the upper and lower sheets 13, 34 remaining substantially flat when inflated.

At one longitudinal end of each inflatable cell 10, 30 is an inflation valve 18, 38. The inflation valve 18, 38 is a one-way valve which can be connected to an air pump to inflate the cavity 24, 44.

Each inflatable cell 10, 30 also has a pressure release valve 19, 39 positioned adjacent to the inflation valve 18, 38. The pressure release valve 19, 39 is configured to release air from within the cavity 24, 44 when the pressure within the cavity 24, 44 exceeds a predetermined level due to over-inflation or applied pressure as a patient is positioned onto the inflatable cell 10, 30. This helps to prevent damage to the seams and prolongs the lifetime of the inflatable support 1. The pressure release valve 19, 39 can also be manually opened to deflate the cell 10, 30. In this particular embodiment, the pressure release valve 19, 39 and the inflation valve 18, 38 are provided in the side wall 17, 37 at one longitudinal end of the cell 10, 30.

The lower sheet 11, 31 has a lower tab 13, 33 extending outwards from the side wall 17, 37 adjacent to the inflation valve 18, 38 and the pressure release valve 19, 39. A similar tab 16, 36 is provided on the upper sheet 14, 34. The tabs partially shield and protect the inflation and pressure release valves. A handle 20, 40 is attached between the two tabs. The handle 20, 40 is formed from a webbing material and is stitched to each tab. The handle 20, 40 can be used to manoeuvre and position the inflatable support 1.

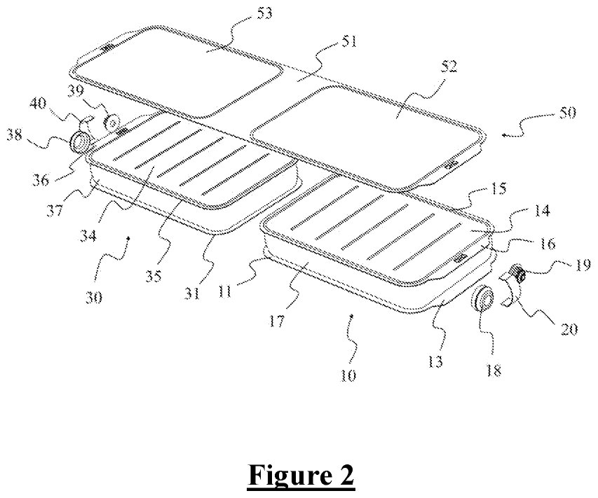

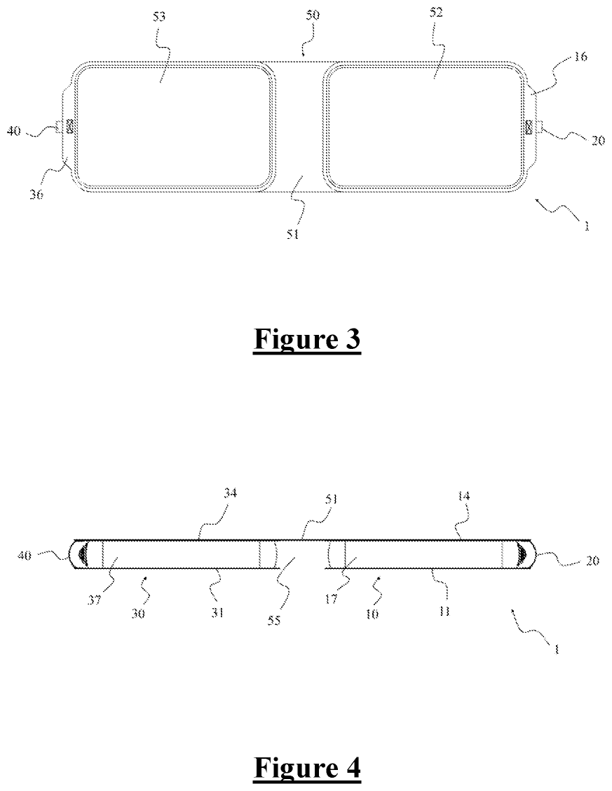

Referring again to FIGS. 2 and 4, the two inflatable cells 10, 30 are connected via their upper sheets 14, 34 by a connection sheet 50. The connection sheet 50 is elongate and has a first cell overlay portion 52 which is attached to and covers the upper sheet 14 of the first inflatable cell 10, a second cell overlay portion 53 which is attached to and covers the upper sheet 34 of the second inflatable cell 30, and a conjoining portion 51 which extends between the two overlay portions 52, 53 across the central channel 55 between the two inflatable cells 10, 30. The connection sheet 50 also extends over the upper tabs 16, 36.

The connection sheet 50 is composed of the same nylon material with a polyurethane coating as the inflatable cells 10, 30, and is attached to the upper sheets 14, 34 by welding around each upper sheet perimeter 15, 35 as best illustrated by FIG. 3.

The two inflatable cells 10, 30 are arranged such that the valves of both cells are on an outward facing end of the inflatable support 1. This ensures they can easily be accessed by operatives.

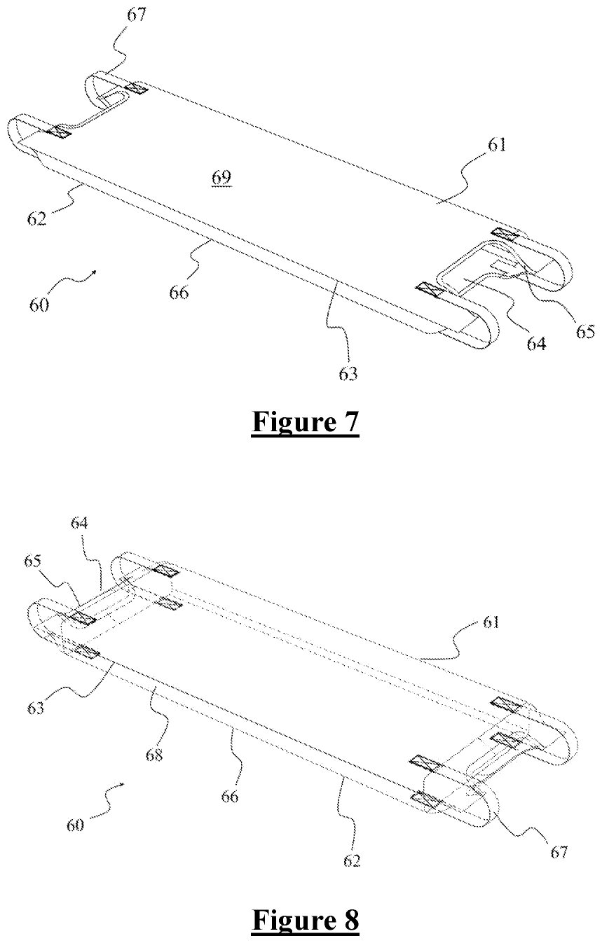

Referring now to FIG. 7, a bag 60 is shown. The bag 60 is designed to encase the inflatable support 1 during use. The use of a bag 60 prolongs the lifetime of the inflatable support 1 by reducing the risk of damage or puncture to the inflatable cells 10, 30. The bag 60 also facilitates re-use of the inflatable support 1 on different patients. After use, the bag 60 can be removed and disposed of (or cleaned for reuse) and replaced. For example, the bag 60 may be for single patient use, i.e. used multiple times with the same patient and then disposed of when damaged or no longer required.

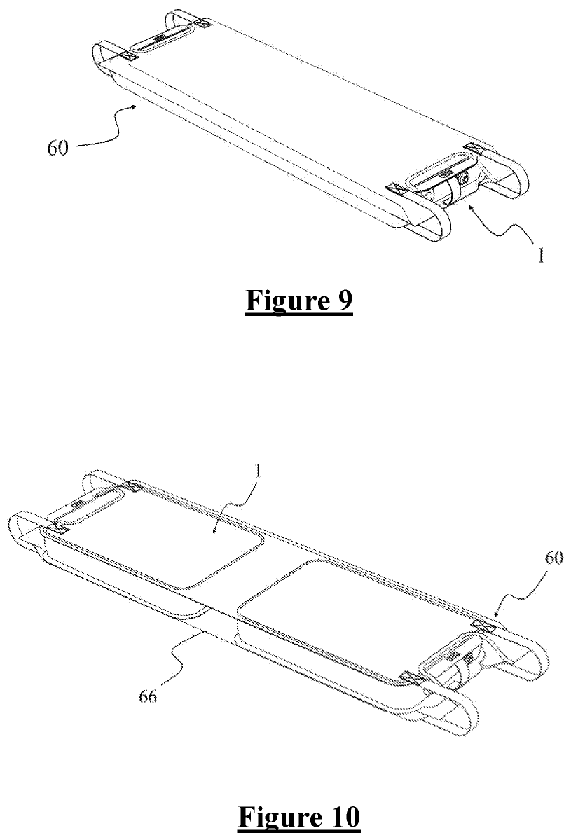

The bag 60 has an elongate shape and is sized to fit snugly around the inflatable support 1 when inflated, as shown in FIG. 9. The bag 60 has a width of approximately 41 cm, a length of approximately 160 cm and a depth of approximately 11 cm. The bag 60 includes a top cover 61 and a bottom cover 62 directly stitched together along each longitudinal edge to provide a tapered edge 63. The top and bottom covers 61, 62 are stitched together along corner portions of transverse edges.

A central portion of each transverse edge is open to define an aperture 64. The apertures 64 enable the inflatable support 1 to be inserted and removed from the bag 60 when deflated, and also allow access to the valves 18, 19, 38, 39 as shown in FIG. 9. In this particular embodiment, the interior surface 68 of the bag 60 is provided with a low-friction silicone coating to facilitate insertion and removal of the inflatable support 1. An exterior surface 69 of the bag 60 is also provided with a low friction silicone coating to facilitate positioning of the inflatable support 1 within the bag 60 underneath a patient, and to facilitate positioning of other devices underneath the inflatable support 1 and the bag 60.

A stitched seam 65 is provided around each aperture 64. The seam 65 provides additional strength to the bag 60 around the aperture 64 to prevent damage as the inflatable support 1 is inserted or removed.

As best shown in FIG. 10, a central portion 66 of the bottom cover 62 of the bag 60 extends across the central channel 55 of the inflatable support 1. When the support 1 is inflated as shown in FIG. 10, the central channel 55 is enclosed on four sides by the conjoining portion 51, the bottom cover 62 and the two inflatable cells 10, 30.

The central channel 55 provides an access route underneath the patient when the support 1 is inflated underneath a patient. Medical staff can easily push their hand underneath the central portion 66 of the bottom cover 62, which will displace upwards into the central channel 55. Equipment can thus be fed underneath the bag 60 and the patient without needing to force it underneath the inflatable cells 10, 30.

The bag 60 includes four grip straps 67 provided towards each corner. Each grip strap 67 is formed from a webbing material and is stitched to the upper cover 61 at one end and to the bottom cover 62 at the other end. The grip straps 67 together with the handles 20, 40 on the inflatable support 1 facilitate the positioning of the inflatable support 1 underneath a patient.

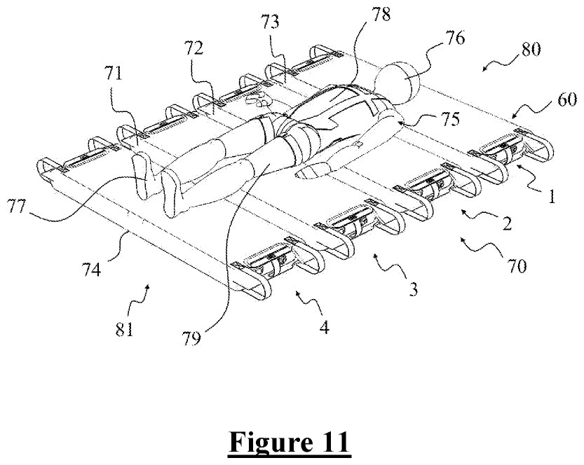

Referring now to FIGS. 11 to 13, a system 70 for supporting a patient 75 is shown. The patient 75 will ordinarily be a bariatric patient but a smaller patient is shown in FIGS. 11 to 13 for illustration. The system 70 has four inflatable supports 1, 2, 3, 4 arranged side-by-side and spaced apart, extending from left to right underneath the patient 75. The inflatable supports 1, 2, 3, 4 are substantially the same and are each housed within a bag 60.

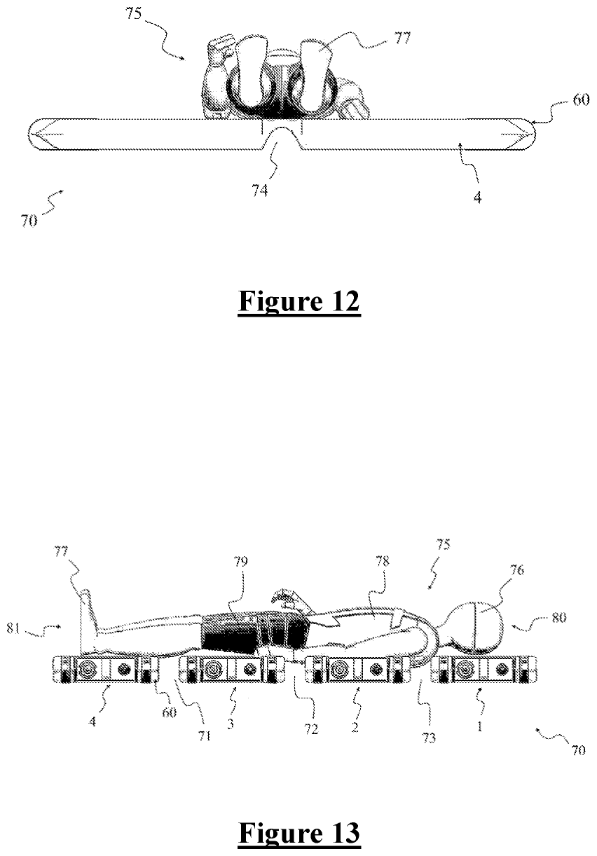

As best illustrated by FIG. 13, the inflatable supports 1, 2, 3, 4 are spaced apart to define sideways channels 71, 72, 73 between adjacent supports 1. As best illustrated by FIGS. 11 and 12, the supports 1, 2, 3, 4 are aligned so that the central channels 55 of the four supports 1, 2, 3, 4 are in alignment to define a lengthwise channel 74 extending underneath the patient 75 from a head end 80 to a foot end 81. The lengthwise channel 74 is accessible when the central portion 66 of each bottom sheet 62 is lifted upwards into the central channel 55 as shown in FIG. 12. The sideways channels 71, 72, 73 and the lengthwise channel 74 together form a network of interlinked access channels underneath the patient 75. This allows other equipment such as a patient handling device (e.g. a repositioning sling, transfer mattress or other device) to be positioned underneath the patient 75.

An example process for positioning a handling device (e.g. a repositioning sling) underneath a bariatric patient 75 using the system 70 of FIGS. 11 to 13 will now be described.

A first inflatable support 1 in a deflated configuration within a bag 60 is positioned underneath the head and shoulders 76 of a patient 75 in a supine position on a substrate (e.g. a mattress). The first inflatable support 1 is then inflated to lift the head and shoulders 76 of the patient 75 away from the substrate. A second inflatable support 2 in a deflated configuration is then pulled from the head end 80 underneath the first (inflated) support 1 down the back of the patient 75 until it is positioned generally underneath the torso 78 of the patient 75. The low friction coating on the external surface 69 of the bag 60 facilitates sliding of the bag 60 and the second inflatable support 2 underneath the patient 75 and the first inflatable support 1. The second inflatable support 2 is then inflated to lift the patient's torso 78 away from the substrate. A third inflatable support 3 in a deflated configuration within a bag 60 is then pulled down from the head end 80 of the patient's body underneath the first and second inflatable supports 1, 2 until the third inflatable support 3 is positioned generally underneath the thighs 79 of the patient 75. The third inflatable support 3 is then inflated to lift the patient's thighs 79 away from the substrate. A fourth inflatable support 4 can then be positioned from the foot end 81 of the patient 75 underneath the calves and feet 77 of the patient 75 and then inflated.

Although the procedure described positions three supports 1, 2, 3 underneath the patient 75 from the head end 80 and one support 4 from the foot end 81, it may be easier or more appropriate to position all four supports 1, 2, 3, 4 from the head end 80, two supports 1, 2 from the head end 80 and two supports 3, 4 from the foot end 81, three supports 2, 3, 4 from the foot end 81 and one support 1 from the head end 80 or all four supports 1, 2, 3, 4 from the foot end.

In most cases, the first inflatable support 1 at the head end is typically positioned and inflated first to relieve pressure from vital organs, with the supports 2, 3, 4 being sequentially positioned and inflated working downwards from the head end 80 to the foot end 81.

A repositioning device (such as a sling or a deflated transfer mattress) can be rolled and fed through one of the sideways channels (e.g. the central sideways channel 72). One end of the repositioning device can then be pulled and slid underneath the inflatable supports 1, 4 towards the foot end 81, and then the other end of the repositioning device can be pulled and slid underneath the inflatable supports 2, 3 towards the head end 80. Alternatively the repositioning device can be rolled lengthwise, fed through the lengthwise channel 74 and unfurled by pulling outwards in one direction underneath the first inflatable pads 10 and in the other direction underneath the second inflatable pads 30.

The inflatable cells 10, 30 can then be deflated, and the inflatable supports 1, 2, 3, 4 can be slid out from underneath the patient 75. The repositioning device is then in position underneath the patient 75 and can be used to move the patient 75. The system 70 of inflatable supports 1, 2, 3, 4 therefore facilitates the positioning of a repositioning device underneath a bariatric patient without excessive manhandling. This reduces the risk of injury to the patient or staff and reduces the number of staff required to move the patient.

To roll or turn a patient 75 onto their side when the inflatable supports 1, 2, 3, 4 are positioned underneath and inflated as shown in FIG. 11, the inflatable cells along one side (e.g. the first inflatable cell 10 of each support or the second inflatable cell 30 of each support) can be deflated to tip the patient in one direction. The inflated cells on the other side can be lifted via the grip straps 67/handles 20, 40 (using a hoist if required) to further tip the patient 75, with the conjoining portion 51 acting as a hinge point.

1. An inflatable support comprising:
first and second inflatable cells aligned and spaced apart along a longitudinal axis to define a central channel, wherein each inflatable cell includes:
an upper sheet in a first plane substantially parallel to the longitudinal axis,
a lower sheet in a second plane substantially parallel to the first plane and to the longitudinal axis,
an inflatable chamber between the upper and lower sheets, and an inflation valve in fluid communication with the inflatable chamber; and
a connection sheet attached to the upper sheet of each inflatable cell, wherein the connection sheet has a conjoining portion extending across the central channel to connect the longitudinally spaced apart first and second inflatable cells.

2. The inflatable support of claim 1, wherein each inflatable cell has a side wall attached to and connecting a perimeter of the upper sheet and a perimeter of the lower sheet, and one or more baffles attached to and connecting the upper and lower sheets within the cavity.

3. The inflatable support of claim 1, wherein each inflatable cell is substantially rectangular having a length extending along the longitudinal axis and a width perpendicular to the longitudinal axis.

4. The inflatable support of claim 3, wherein each inflatable cell has a length of between 60 cm and 80 cm, a width of between 35 cm and 50 cm, and a depth of between 7 cm and 15 cm.

5. The inflatable support of claim 1, wherein the inflation valve is positioned at or towards an external facing end of each inflatable cell.

6. The inflatable support of claim 1, wherein each inflatable cell is composed of a flexible non-porous material selected from a group consisting of natural or synthetic rubber, a polyethylene vinyl acetate (PEVA), a nylon material with a polyurethane coating, or a polyvinyl chloride (PVC).

7. The inflatable support of claim 1, wherein the connection sheet extends over the entirety of the upper sheet of each inflatable cell.

8. The inflatable support of claim 1, wherein the connection sheet is composed of the same material as the inflatable cells and is attached to the inflatable cells by welding.

9. The inflatable support of claim 1, wherein the first and second inflatable cells are spaced apart to define a central channel having a width of between 15 cm and 30 cm.

10. The inflatable support of claim 1, further comprising an elongate bag to surround and contain the inflatable cells and connection sheet, wherein the bag is sized to snugly fit around the inflatable cells and connection sheet when the cells are fully inflated and has:
a top cover positioned over the upper sheets and the connection sheet; and
a bottom cover positioned over the lower sheets.

11. The inflatable support of claim 10, wherein the top cover and the bottom cover are directly attached to each other along each longitudinal edge to provide a tapered edge.

12. The inflatable support of claim 10, wherein the top and bottom covers are composed of a flexible, non-porous material and are coated on outward and inward facing surfaces with a low friction material selected from a group consisting of polytetrafluoroethylene (PTFE), fluorinated ethylene propylene (FEP) and silicone.

13. A kit of parts comprising:
a pair of inflatable cells, wherein each inflatable cell includes an upper sheet, a lower sheet, an inflatable chamber between the upper and lower sheets, and an inflation valve in fluid communication with the inflatable chamber; and
an elongate bag, wherein the bag is sized to snugly fit around the inflatable cells when the cells are fully inflated and has a top cover positionable over the upper sheets and a bottom cover positionable over the lower sheets.

14. The kit of claim 13, wherein the top cover and the bottom cover are directly attached to each other along each longitudinal edge to provide a tapered edge.

15. The kit of claim 13, wherein the pair of inflatable cells are joined together by a connection sheet attached to the upper sheet of each inflatable cell.

16. A system for lifting and supporting a patient, comprising two or more inflatable supports according to claim 1.

17. The system of claim 16, wherein the system comprises exactly four inflatable supports.

18. An elongate bag for surrounding and containing the inflatable support of claim 1, comprising:
a top cover positioned over the upper sheets and the connection sheet;
a bottom cover positioned over the lower sheets; and
an aperture between the top and bottom covers at each longitudinal end of the bag; wherein the top cover and the bottom cover are directly attached to each other along each longitudinal edge to provide a tapered edge.
